(19) United States
(12) Patent Application Publication
(10) Pub. No.: US 2021/0221229 A1
(43) Pub. Date: Jul. 22, 2021

(54) TRAIN

(71) Applicant: CRRC QINGDAO SIFANG CO., LTD., Qingdao (CN)

(72) Inventors: Miao WANG, Qingdao (CN); Huiqing ZHANG, Qingdao (CN); Qing TIAN, Qingdao (CN); Baoqiang SHAN, Qingdao (CN); Yinan MOU, Qingdao (CN)

(21) Appl. No.: 16/303,814

(22) PCT Filed: Sep. 29, 2018
(86) PCT No.: PCT/CN2018/108763

§ 371 Date: Nov. 21, 2018

(30) Foreign Application Priority Data
Jun. 25, 2018 (CN) 201820989018.2

(51) Int. Cl. B60L 5/02; B60L 5/20

(52) U.S. Cl. CPC B60L 5/02; B60L 2200/26; B60L 5/20

(57) ABSTRACT

A train includes: a body, a pantagraph current collector and an ice scraper, wherein the pantagraph current collector is provided on the body; and the ice scraper is mounted on the pantagraph current collector, and the ice scraper is in contact with a power supply rail, so as to remove ice on the power supply rail during the movement of the body. Thus, it is ensured that the pantagraph current collector can be in effective contact with the power supply rail during the running of the train, and normal power supply of the train is ensured. The problem in the conventional art in which the current receiving performance of a current receiver of a train is greatly reduced when a power supply rail is frozen or suffers from heavy snow is solved.

### TECHNICAL FIELD

Embodiments of the present disclosure relate to the field of a deicing equipment, and in particular to a train.

### BACKGROUND

Rail traffic means a class of vehicle or transportation systems for trains that need to run on specific rails. The most typical rail traffic is a railway system composed of a traditional train and a standard railway. With the diversified development of train and railway technologies, the rail traffic presents increasing types, not only covers long-distance land transportation, but also is widely applied to medium-short distance urban public traffic.

A pantagraph current collector is a power supply device for a train, and the running stability thereof affects the normal running of the train. When a power supply rail is frozen or suffers from heavy snow at a low external temperature, the current receiving performance of the pantagraph current collector is greatly reduced since the pantagraph current collector cannot be in effective contact with the power supply rail, thus delaying the operation of the train.

### SUMMARY

An objective of embodiments of the present disclosure is to provide a train, intended to solve the problem in the conventional art in which the current receiving performance of a pantagraph current collector of a train is greatly reduced when a power supply rail is frozen or suffers from heavy snow.

To achieve the above objective, embodiments of the present disclosure provide a train, including: a body; a pantagraph current collector, provided on the body; and an ice scraper, mounted on the pantagraph current collector, the ice scraper being in contact with a power supply rail, so as to remove ice on the power supply rail during a movement of the body.

In some embodiments, there are two pantagraph current collectors, there are two power supply rails, and the two pantagraph current collectors are in one-to-one correspondence with the two power supply rails; wherein there are two ice scrapers, the two ice scrapers are mounted on the two pantagraph current collectors in one-to-one correspondence and are in corresponding contact with the two power supply rails to remove ice on the two power supply rails.

In some embodiments, the train further includes an ice melting device, at least a part of the ice melting device is opposite to the two power supply rails, so as to melt the ice on the two power supply rails.

In some embodiments, the ice melting device includes: an ice melting liquid storage tank, mounted on the body, the ice melting liquid storage tank being configured to store ice melting liquid; and two ice melting pipelines, wherein one ends of the two ice melting pipelines are communicated with the ice melting liquid storage tank, and the other ends of the two ice melting pipelines correspond to the two power supply rails respectively, so as to spray the ice melting liquid to the power supply rails.

In some embodiments, the ice melting device further includes: a control valve, provided in the ice melting liquid storage tank, and configured to open or close the ice melting liquid storage tank so as to control the ice melting liquid to flow out of the ice melting liquid storage tank.

In some embodiments, the ice melting device further includes: an ice detection sensor, provided on the body and connected with the control valve, the ice detection sensor is configured to detect whether the power supply rails are covered with ice, wherein when detecting that the power supply rails are covered with ice, the ice detection sensor sends a sensing signal to the control valve, so that the control valve controls the ice melting liquid storage tank to be opened.

In some embodiments, there are two ice detection sensors, the two ice detection sensors corresponding to the two power supply rails.

In some embodiments, the ice detection sensor includes: a camera, configured to shoot an image of the power supply rails to judge whether the power supply rails are covered with ice; and a temperature sensor, configured to sense a temperature of an environment where the power supply rails are located.

In some embodiments, the train further includes: a high tension equipment, provided in the body; and a power supply rail detection device, the two pantagraph current collectors are connected with the high tension equipment through the power supply rail detection device respectively, wherein the power supply rail detection device is configured to detect voltage and/or current of the pantagraph current collectors so as to determine whether a corresponding power supply rail in power supply rails normally supplies power, and the ice melting device is configured to melt ice on one power supply rail that normally supplies power.

In some embodiments, the power supply rail detection device includes: two voltage sensors and/or two current sensors, each pantagraph current collector is connected with the high tension equipment through a corresponding voltage sensor in the two voltage sensors and/or a corresponding current sensor in the two current sensors.

The train according to the technical solution of embodiments of the present disclosure includes: a body, a pantagraph current collector and an ice scraper, wherein the pantagraph current collector is provided on the body; and the ice scraper is mounted on the pantagraph current collector, and the ice scraper is in contact with a power supply rail, so as to remove ice on the power supply rail during the movement of the body. Thus, it is ensured that the pantagraph current collector can be in effective contact with the power supply rail during the running of the train, and normal power supply of the train is ensured. The problem in the conventional art in which the current receiving performance of a pantagraph current collector of a train is greatly reduced when a power supply rail is frozen or suffers from heavy snow is solved.

### BRIEF DESCRIPTION OF THE DRAWINGS

The accompanying drawings, which constitute a part of the present application, are used to provide a further understanding of the present disclosure, and the exemplary embodiments of the present disclosure and the description thereof are used to explain the present disclosure, but do not constitute improper limitations to the present disclosure. In the drawings:

FIG. 1 is an optional structural schematic diagram of a train according to an embodiment of the present disclosure.

The drawing includes the following reference signs:

10: pantagraph current collector; 20: power supply rail; 30: ice melting device; 31: ice melting liquid storage tank; 32: ice melting pipeline; 33: ice detection sensor; 40: high tension equipment; 50: power supply rail detection device; 60: body.

### DETAILED DESCRIPTION OF THE EMBODIMENTS

It is to be noted that in the case of no conflict, the features in the embodiments and the embodiments in the present application may be combined with each other. The present disclosure is described below with reference to the drawings and in conjunction with the embodiments in detail.

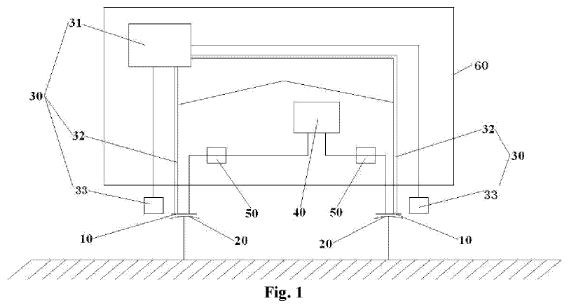

As shown in FIG. 1, a train according to an embodiment of the present disclosure includes a body 60, a pantagraph current collector 10 and an ice scraper, wherein the pantagraph current collector 10 is provided on the body 60; and the ice scraper is mounted on the pantagraph current collector 10, and the ice scraper is in contact with a power supply rail 20, so as to remove ice on the power supply rail 20 during the movement of the body 60.

The train according to the technical solution of the embodiment of the present disclosure includes: a body 60, a pantagraph current collector 10 and an ice scraper, wherein the pantagraph current collector 10 is provided on the body 60; and the ice scraper is mounted on the pantagraph current collector 10, and the ice scraper is in contact with a power supply rail, so as to remove ice on the power supply rail during the movement of the body 60. Thus, it is ensured that the pantagraph current collector 10 can be in effective contact with the power supply rail 20 during the running of the train, and normal power supply of the train is ensured. The problem in the conventional art in which the current receiving performance of a current receiver of a train is greatly reduced when the power supply rail 20 is frozen or suffers from heavy snow is solved.

During specific implementation, there are two pantagraph current collectors 10, there are two power supply rails 20, and the two pantagraph current collectors 10 are in one-to-one correspondence with the two power supply rails 20; there are two ice scrapers, the two ice scrapers are mounted on the two pantagraph current collectors 10 in one-to-one correspondence and are in corresponding contact with the two power supply rails 20 to remove ice on the two power supply rails 20 during the movement of the body, so that it is ensured that the pantagraph current collectors 10 can be in well contact with the power supply rails 20.

In order to thoroughly remove the ice on the power supply rails 20, the train further includes an ice melting device 30, at least a part of the ice melting device 30 being opposite to the two power supply rails 20, so as to melt the ice on the two power supply rails 20.

Specifically, the ice melting device 30 includes an ice melting liquid storage tank 31, melting pipelines 32, a control valve and an ice detection sensor 33. The ice melting liquid storage tank 31 is mounted on the body 60, and the ice melting liquid storage tank 31 is configured to store ice melting liquid. There are two ice melting pipelines 32, one end of each ice melting pipeline 32 is communicated with the ice melting liquid storage tank 31, and the other ends of two ice melting pipelines 32 correspond to the two power supply rails 20 respectively. The control valve is provided in the ice melting liquid storage tank 31, and configured to open or close the ice melting liquid storage tank 31 so as to control the ice melting liquid to flow out of the ice melting liquid storage tank 31. During the movement of the body, the ice melting liquid flowing out of the two ice melting pipelines 32 is sprayed to the two power supply rails 20 respectively, so that ice that is not scraped by the ice scraper can be thoroughly removed.

The ice melting device 30 needs to be controlled and started according to the situation of ice on the power supply rails 20, if the power supply rails 20 are covered with ice, the ice melting device 30 is started, and if the power supply rails 20 are not covered with ice, the ice melting device 30 is closed. Further, the ice melting device 30 also includes ice detection sensors 33. There are two ice detection sensors 33, and the two ice detection sensors 33 correspond to the two power supply rails 20. The ice detection sensor 33 is provided on the body 60 and connected with the control valve, the ice detection sensor 33 is configured to detect whether the power supply rails 20 are covered with ice, when detecting that the power supply rails 20 are covered with ice, the ice detection sensor 33 sends a sensing signal to the control valve, and the control valve controls the ice melting liquid storage tank 31 to be opened, so as to spray the ice melting liquid to the power supply rails 20 to remove the ice.

Optionally, the ice detection sensor 33 includes a camera and a temperature sensor, the camera is configured to shoot images of the power supply rails 20 to judge whether the power supply rails 20 are covered with ice, and the temperature sensor is configured to sense the temperature of an environment where the power supply rails 20 are located. The accuracy of ice judgment can be improved by combining the camera and the temperature sensor.

Only the power supply rail 20 on one side is needed to supply power during the actual running process of the train, and the power supply rails 20 are switched according to different running directions of the train. In order to determine which power supply rail 20 supplies power before the train is started, the train further includes a high tension equipment 40 and a power supply rail detection device 50. The high tension equipment 40 is provided in the body 60. The power supply rail detection device 50 includes two voltage sensors and/or two current sensors, and each pantagraph current collector 10 is connected with the high tension equipment 40 through a corresponding voltage sensor in the two voltage sensors and/or a corresponding current sensor in the two current sensors. The voltage sensors and/or the current sensors detect the voltage and/or current of the pantagraph current collectors 10 to determine whether a corresponding power supply rail 20 in power supply rails 20 normally supply power, so as to judge which power supply rail 20 supplies power. During the running process of the train, only one ice melting pipeline 32, corresponding to one power supply rail 20 that is supplying power, in the two ice melting pipelines 32 of the ice melting device 30 is needed for ice melting, so that the ice melting liquid can be saved.

The above is only the preferred embodiments of the present disclosure, not intended to limit the present disclosure. As will occur to those skilled in the art, the present disclosure is susceptible to various modifications and changes. Any modifications, equivalent replacements, improvements and the like made within the spirit and principle of the present disclosure shall fall within the scope of protection of the present disclosure.

What is claimed is:

1. A train, comprising:
a body (60);
a pantagraph current collector (10), provided on the body (60); and
an ice scraper, mounted on the pantagraph current collector (10), the ice scraper being in contact with a power supply rail (20), so as to remove ice on the power supply rail (20) during a movement of the body (60).

2. The train as claimed in claim 1, wherein there are two pantagraph current collectors (10), there are two power supply rails (20), and the two pantagraph current collectors (10) are in one-to-one correspondence with the two power supply rails (20);
wherein there are two ice scrapers, the two ice scrapers are mounted on the two pantagraph current collectors (10) in one-to-one correspondence and are in corresponding contact with the two power supply rails (20) to remove ice on the two power supply rails (20).

3. The train as claimed in claim 2, further comprising:
an ice melting device (30), at least a part of the ice melting device (30) being opposite to the two power supply rails (20), so as to melt the ice on the two power supply rails (20).

4. The train as claimed in claim 3, wherein the ice melting device (30) comprises:
an ice melting liquid storage tank (31), mounted on the body (60), the ice melting liquid storage tank (31) being configured to store ice melting liquid; and
two ice melting pipelines (32), wherein one ends of the two ice melting pipelines (32) are communicated with the ice melting liquid storage tank (31), and the other ends of the two ice melting pipelines (32) correspond to the two power supply rails (20) respectively, so as to spray the ice melting liquid to the power supply rails (20).

5. The train as claimed in claim 4, wherein the ice melting device (30) further comprises:
a control valve, provided in the ice melting liquid storage tank (31), and configured to open or close the ice melting liquid storage tank (31) so as to control the ice melting liquid to flow out of the ice melting liquid storage tank (31).

6. The train as claimed in claim 5, wherein the ice melting device (30) further comprises:
an ice detection sensor (33), provided on the body (60) and connected with the control valve, the ice detection sensor (33) being configured to detect whether the power supply rails (20) are covered with ice,
wherein when detecting that the power supply rails (20) are covered with ice, the ice detection sensor (33) sends a sensing signal to the control valve, so that the control valve controls the ice melting liquid storage tank (31) to be opened.

7. The train as claimed in claim 6, wherein there are two ice detection sensors (33), the two ice detection sensors (33) corresponding to the two power supply rails (20).

8. The train as claimed in claim 6, wherein the ice detection sensor (33) comprises:
a camera, configured to shoot an image of the power supply rails (20) to judge whether the power supply rails (20) are covered with ice; and
a temperature sensor, configured to sense a temperature of an environment where the power supply rails (20) are located.

9. The train as claimed in claim 3, further comprising:
a high tension equipment (40), provided in the body (60); and
a power supply rail detection device (50), the two pantagraph current collectors (10) being connected with the high tension equipment (40) through the power supply rail detection device (50) respectively,
wherein the power supply rail detection device (50) is configured to detect voltage and/or current of the pantagraph current collectors (10) so as to determine whether a corresponding power supply rail (20) in power supply rails (20) normally supplies power, and the ice melting device (30) is configured to melt ice on one power supply rail (20) that normally supplies power.

10. The train as claimed in claim 9, wherein the power supply rail detection device (50) comprises:
two voltage sensors and/or two current sensors, each pantagraph current collector (10) being connected with the high tension equipment (40) through a corresponding voltage sensor in the two voltage sensors and/or a corresponding current sensor in the two current sensors.
